(19) United States
(12) Patent Application Publication
(10) Pub. No.: US 2020/0050191 A1
(43) Pub. Date: Feb. 13, 2020

(54) PERCEPTION UNCERTAINTY MODELING FROM ACTUAL PERCEPTION SYSTEMS FOR AUTONOMOUS DRIVING

(71) Applicant: GM GLOBAL TECHNOLOGY OPERATIONS LLC, Detroit, MI (US)

(72) Inventors: HYUKSEONG KWON, THOUSAND OAKS, CA (US); KYUNGNAM KIM, OAK PARK, CA (US)

(73) Assignee: GM GLOBAL TECHNOLOGY OPERATIONS LLC, Detroit, MI (US)

(21) Appl. No.: 16/057,084

(22) Filed: Aug. 7, 2018

(51) Int. Cl. G05D 1/00; G06N 99/00; G05D 1/02; G06N 5/04

(52) U.S. Cl. CPC G05D 1/0044; G05D 1/0088; G06N 5/048; G05D 1/0246; G06N 99/005

(57) ABSTRACT

Systems and method are provided for controlling an autonomous vehicle. In one embodiment, a method includes: receiving sensor data from one or more sensors of the vehicle; processing, by a processor, the sensor data to determine object data indicating at least one element within a scene of an environment of the vehicle; processing, by the processor, the sensor data to determine a ground truth data associated with the element; determining, by the processor, an uncertainty model based on the ground truth data and the object data; training, by the processor, vehicle functions based on the uncertainty model; and controlling the vehicle based on the trained vehicle functions.

### INTRODUCTION

The present disclosure generally relates to autonomous vehicles, and more particularly relates to systems and methods for modeling perception system uncertainties used in training decision making functions that control an autonomous vehicle.

An autonomous vehicle is a vehicle that is capable of sensing its environment and navigating with little or no user input. An autonomous vehicle generally includes a perception system that senses its environment using sensing devices such as radar, lidar, image sensors, and the like and that processes the sensor information to understand the surrounding environment and navigate the vehicle. The autonomous vehicle system further uses information from global positioning systems (GPS) technology, navigation systems, vehicle-to-vehicle communication, vehicle-to-infrastructure technology, and/or drive-by-wire systems to navigate the vehicle.

While autonomous vehicles and semi-autonomous vehicles offer many potential advantages over traditional vehicles, in certain circumstances it may be desirable for improved operation of the vehicles. For example, in certain instances decision making functions of an autonomous vehicle often require training. Training is often performed using a plethora of real world data obtained through the perception system. Obtaining such data and training the decision making functions can be time consuming and costly.

Accordingly, it is desirable to provide systems and methods that model perception system uncertainties and use the models in training the decision making functions. The models can be used in place of the plethora of real world data thus, saving time and cost of development. Furthermore, other desirable features and characteristics of the present invention will become apparent from the subsequent detailed description and the appended claims, taken in conjunction with the accompanying drawings and the foregoing technical field and background.

### SUMMARY

Systems and method are provided for controlling an autonomous vehicle. In one embodiment, a method includes: receiving sensor data from one or more sensors of the vehicle; processing, by a processor, the sensor data to determine object data indicating at least one element within a scene of an environment of the vehicle; processing, by the processor, the sensor data to determine a ground truth data associated with the element; determining, by the processor, an uncertainty model based on the ground truth data and the object data; training, by the processor, vehicle functions based on the uncertainty model; and controlling the vehicle based on the trained vehicle functions.

In various embodiments, the uncertainty model includes a range uncertainty. In various embodiments, the uncertainty model includes an orientation uncertainty. In various embodiments, the uncertainty model includes a velocity uncertainty.

In various embodiments, the determining the uncertainty model is based on a comparison of an object location of the object data to a ground truth location of the ground truth data.

In various embodiments, the training includes generating perception system data based on the uncertainty model and training the vehicle functions based on the generated perception system data.

In various embodiments, the object data includes a bounding box surrounding the element within the scene, wherein the bounding box is identified by an object detection method.

In various embodiments, the object data further includes a distance to the element from the vehicle and a location of the element within the scene that is determined based on the bounding box.

In various embodiments, the ground truth data includes a bounding box surrounding the element within the scene, wherein the bounding box is identified by a ground truth detection method.

In various embodiments, the ground truth data further includes a distance to the element from the vehicle and a location of the element within the scene that is determined based on the bounding box.

In one embodiment, a system for an autonomous vehicle includes: a non-transitory computer readable medium including: a first module configured to, by a processor, receive sensor data from one or more sensors of the vehicle, process the sensor data to determine object data indicating at least one element within a scene of an environment of the vehicle, and process the sensor data to determine a ground truth data associated with the element; a second non-transitory module configured to, by a processor, determine an uncertainty model based on the ground truth data and the object data; and a third module configured to, by a processor, generate perception system data based on the uncertainty model and training vehicle functions of a vehicle controller based on the generated perception system data.

In various embodiments, the uncertainty model includes a range uncertainty. The system of claim 11, wherein the uncertainty model includes an orientation uncertainty. In various embodiments, the uncertainty model includes a velocity uncertainty.

In various embodiments, the uncertainty model is based on a comparison of an object location of the object data to a ground truth location of the ground truth data. In various embodiments, the object data includes a bounding box surrounding the element within the scene, wherein the bounding box is identified by an object detection method.

In various embodiments, the object data further includes a distance to the element from the vehicle and a location of the element within the scene that is determined based on the bounding box. In various embodiments, the ground truth data includes a bounding box surrounding the element within the scene, wherein the bounding box is identified by a ground truth detection method.

In various embodiments, the ground truth data further includes a distance to the element from the vehicle and a location of the element within the scene that is determined based on the bounding box.

In one embodiment an autonomous vehicle includes: a plurality of sensors disposed about the vehicle and configured to sense an exterior environment of the vehicle and to generate sensor signals; and a control module configured to, by a processor, process the sensor signals to determine object data indicating at least one element within a scene of an environment of the vehicle, process the sensor data to determine a ground truth data associated with the element, determine, an uncertainty model based on the ground truth data and the object data, train vehicle functions based on the uncertainty model, and control the vehicle based on the trained vehicle functions.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an autonomous vehicle having a training system, in accordance with various embodiments;

FIG. 2 is a functional block diagram illustrating a transportation system having one or more autonomous vehicles of FIG. 1, in accordance with various embodiments;

FIGS. 3 and 4 are dataflow diagrams illustrating an autonomous driving system that includes the training system of the autonomous vehicle, in accordance with various embodiments; and

FIG. 5 is a flowchart illustrating a control method for controlling the autonomous vehicle, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

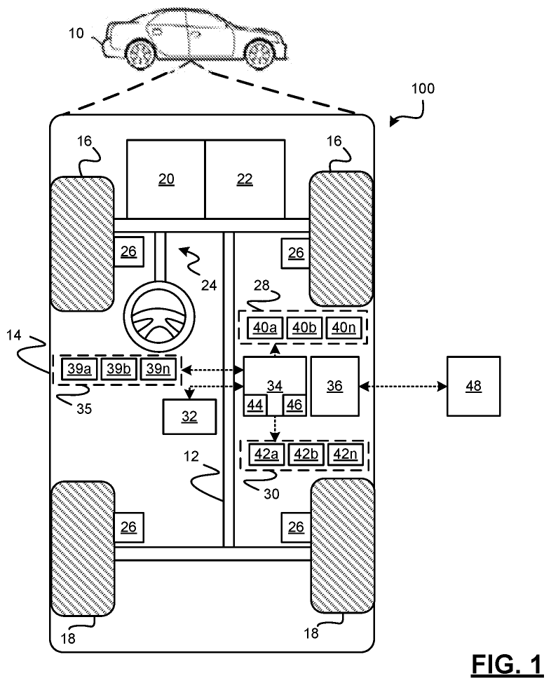

With reference to FIG. 1, a training system shown generally at 100 is associated with a vehicle 10 in accordance with various embodiments. In general, the training system 100 obtains sensor information sensed from an environment of the vehicle 10, develops an uncertainty model from the sensor information, and trains decision making functions of the vehicle using the developed uncertainty model. For exemplary purposes, the disclosure will be discussed in the context of the training performed by the training system 100 being performed onboard the vehicle 10. As can be appreciated, all or parts of the training system 100 can be performed offline and/or remote from the vehicle 10, in various embodiments.

As depicted in FIG. 1, the exemplary vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 is an autonomous vehicle and the training system 100 described herein is incorporated into the autonomous vehicle (hereinafter referred to as the autonomous vehicle 10). The autonomous vehicle 10 is, for example, a vehicle that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. In an exemplary embodiment, the autonomous vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the autonomous vehicle 10 generally includes a propulsion system 20, a transmission system 22, a steering system 24, a brake system 26, a sensor system 28, an actuator system 30, at least one data storage device 32, at least one controller 34, a notification system 25, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16-18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16-18. The brake system 26 may, in various embodiments, include friction brakes, brake by wire, a regenerative braking system such as an electric machine, and/or other appropriate braking systems. The steering system 24 influences a position of the of the vehicle wheels 16-18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, inertial measurement units, and/or other sensors. The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

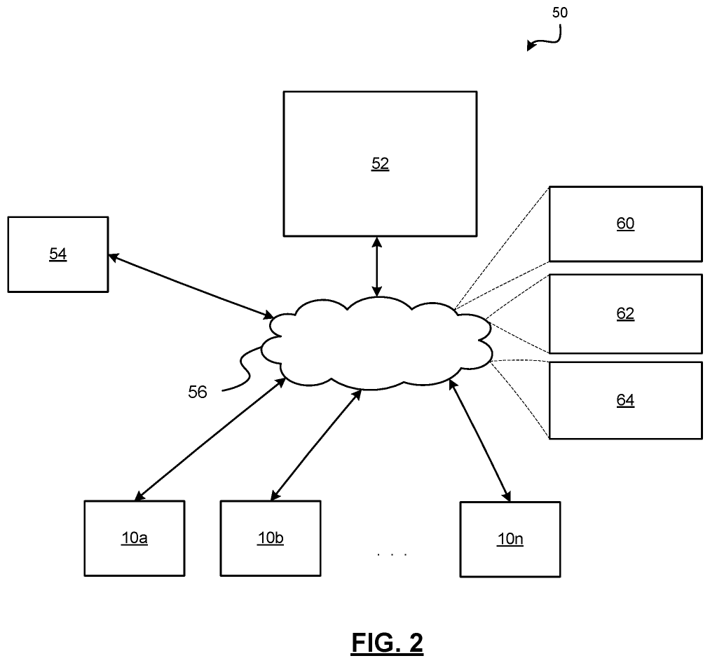

The communication system 36 is configured to wirelessly communicate information to and from other entities 48, such as but not limited to, other vehicles (“V2V” communication,) infrastructure (“V2I” communication), remote systems, and/or personal devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in automatically controlling the autonomous vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the autonomous vehicle 10 (wirelessly and/or in a wired manner) and stored in the data storage device 32. Route information may also be stored within data storage device 32—i.e., a set of road segments (associated geographically with one or more of the defined maps) that together define a route that the user may take to travel from a start location (e.g., the user's current location) to a target location. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10. In various embodiments, the controller 34 is configured to implement the behavior planning systems and methods as discussed in detail below.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms. Although only one controller 34 is shown in FIG. 1, embodiments of the autonomous vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

In various embodiments, one or more instructions of the controller 34 are embodied in the training system 100 and, when executed by the processor 44, process sensor data and/or map data to determine an uncertainty model, train one or more decision making functions based on the uncertainty model, and generate control signals to control the vehicle 10 based on the trained uncertainty model.

With reference now to FIG. 2, in various embodiments, the autonomous vehicle 10 described with regard to FIG. 1 may be suitable for use in the context of a taxi or shuttle system in a certain geographical area (e.g., a city, a school or business campus, a shopping center, an amusement park, an event center, or the like) or may simply be managed by a remote system. For example, the autonomous vehicle 10 may be associated with an autonomous vehicle based remote transportation system. FIG. 2 illustrates an exemplary embodiment of an operating environment shown generally at 50 that includes an autonomous vehicle based remote transportation system 52 that is associated with one or more autonomous vehicles 10a-10n as described with regard to FIG. 1. In various embodiments, the operating environment 50 further includes one or more user devices 54 that communicate with the autonomous vehicle 10 and/or the remote transportation system 52 via a communication network 56.

The communication network 56 supports communication as needed between devices, systems, and components supported by the operating environment 50 (e.g., via tangible communication links and/or wireless communication links). For example, the communication network 56 can include a wireless carrier system 60 such as a cellular telephone system that includes a plurality of cell towers (not shown), one or more mobile switching centers (MSCs) (not shown), as well as any other networking components required to connect the wireless carrier system 60 with a land communications system. Each cell tower includes sending and receiving antennas and a base station, with the base stations from different cell towers being connected to the MSC either directly or via intermediary equipment such as a base station controller. The wireless carrier system 60 can implement any suitable communications technology, including for example, digital technologies such as CDMA (e.g., CDMA2000), LTE (e.g., 4G LTE or 5G LTE), GSM/GPRS, or other current or emerging wireless technologies. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from including the wireless carrier system 60, a second wireless carrier system in the form of a satellite communication system 64 can be included to provide uni-directional or bi-directional communication with the autonomous vehicles 10a-10n. This can be done using one or more communication satellites (not shown) and an uplink transmitting station (not shown). Uni-directional communication can include, for example, satellite radio services, wherein programming content (news, music, etc.) is received by the transmitting station, packaged for upload, and then sent to the satellite, which broadcasts the programming to subscribers. Bi-directional communication can include, for example, satellite telephony services using the satellite to relay telephone communications between the vehicle 10 and the station. The satellite telephony can be utilized either in addition to or in lieu of the wireless carrier system 60.

A land communication system 62 may further be included that is a conventional land-based telecommunications network connected to one or more landline telephones and connects the wireless carrier system 60 to the remote transportation system 52. For example, the land communication system 62 may include a public switched telephone network (PSTN) such as that used to provide hardwired telephony, packet-switched data communications, and the Internet infrastructure. One or more segments of the land communication system 62 can be implemented through the use of a standard wired network, a fiber or other optical network, a cable network, power lines, other wireless networks such as wireless local area networks (WLANs), or networks providing broadband wireless access (BWA), or any combination thereof. Furthermore, the remote transportation system 52 need not be connected via the land communication system 62, but can include wireless telephony equipment so that it can communicate directly with a wireless network, such as the wireless carrier system 60.

Although only one user device 54 is shown in FIG. 2, embodiments of the operating environment 50 can support any number of user devices 54, including multiple user devices 54 owned, operated, or otherwise used by one person. Each user device 54 supported by the operating environment 50 may be implemented using any suitable hardware platform. In this regard, the user device 54 can be realized in any common form factor including, but not limited to: a desktop computer; a mobile computer (e.g., a tablet computer, a laptop computer, or a netbook computer); a smartphone; a video game device; a digital media player; a piece of home entertainment equipment; a digital camera or video camera; a wearable computing device (e.g., smart watch, smart glasses, smart clothing); or the like. Each user device 54 supported by the operating environment 50 is realized as a computer-implemented or computer-based device having the hardware, software, firmware, and/or processing logic needed to carry out the various techniques and methodologies described herein. For example, the user device 54 includes a microprocessor in the form of a programmable device that includes one or more instructions stored in an internal memory structure and applied to receive binary input to create binary output. In some embodiments, the user device 54 includes a GPS module capable of receiving GPS satellite signals and generating GPS coordinates based on those signals. In other embodiments, the user device 54 includes cellular communications functionality such that the device carries out voice and/or data communications over the communication network 56 using one or more cellular communications protocols, as are discussed herein. In various embodiments, the user device 54 includes a visual display, such as a touch-screen graphical display, or other display.

The remote transportation system 52 includes one or more backend server systems, which may be cloud-based, network-based, or resident at the particular campus or geographical location serviced by the remote transportation system 52. The remote transportation system 52 can be manned by a live advisor, or an automated advisor, or a combination of both. The remote transportation system 52 can communicate with the user devices 54 and the autonomous vehicles 10a-10n to schedule rides, dispatch autonomous vehicles 10a-10n, and the like. In various embodiments, the remote transportation system 52 stores account information such as subscriber authentication information, vehicle identifiers, profile records, behavioral patterns, and other pertinent sub scriber information.

In accordance with a typical use case workflow, a registered user of the remote transportation system 52 can create a ride request via the user device 54. The ride request will typically indicate the passenger's desired pickup location (or current GPS location), the desired destination location (which may identify a predefined vehicle stop and/or a user-specified passenger destination), and a pickup time. The remote transportation system 52 receives the ride request, processes the request, and dispatches a selected one of the autonomous vehicles 10a-10n (when and if one is available) to pick up the passenger at the designated pickup location and at the appropriate time. The remote transportation system 52 can also generate and send a suitably configured confirmation message or notification to the user device 54, to let the passenger know that a vehicle is on the way.

As can be appreciated, the subject matter disclosed herein provides certain enhanced features and functionality to what may be considered as a standard or baseline autonomous vehicle 10 and/or an autonomous vehicle based remote transportation system 52. To this end, an autonomous vehicle and autonomous vehicle based remote transportation system can be modified, enhanced, or otherwise supplemented to provide the additional features described in more detail below.

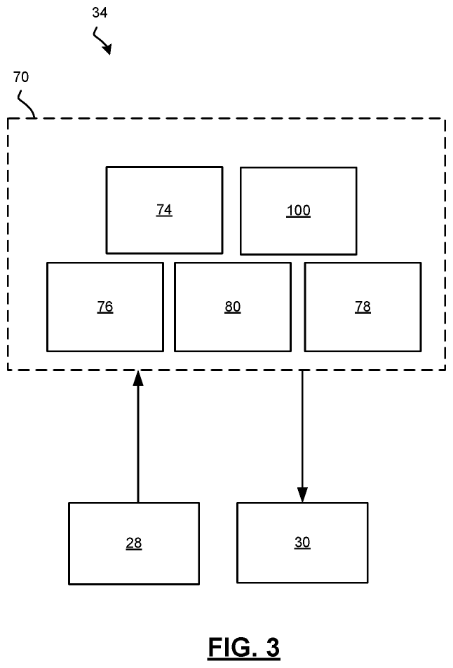

In accordance with various embodiments, the controller 34 implements an autonomous driving system (ADS) 70 as shown in FIG. 3. That is, suitable software and/or hardware components of the controller 34 (e.g., the processor 44 and the computer-readable storage device 46) are utilized to provide an autonomous driving system 70 that is used in conjunction with vehicle 10.

In various embodiments, the instructions of the autonomous driving system 70 may be organized by function, module, or system. For example, as shown in FIG. 3, the autonomous driving system 70 can include a perception system 74, a positioning system 76, a guidance system 78, and a vehicle control system 80. As can be appreciated, in various embodiments, the instructions may be organized into any number of systems (e.g., combined, further partitioned, etc.) as the disclosure is not limited to the present examples.

In various embodiments, the perception system 74 synthesizes and processes sensor data and predicts the presence, location, classification, and/or path of objects and features of the environment of the vehicle 10. In various embodiments, the perception system 74 can incorporate information from multiple sensors, including but not limited to cameras, lidars, radars, and/or any number of other types of sensors.

The positioning system 76 processes sensor data along with other data to determine a position (e.g., a local position relative to a map, an exact position relative to lane of a road, vehicle heading, velocity, etc.) of the vehicle 10 relative to the environment. The guidance system 78 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like.

As mentioned briefly above, the training system 100 of FIG. 1 may be included within the ADS 70, for example, as part of any one of or a combination of the perception system 74, the guidance system 78, and the vehicle control system 80, or as a separate system as shown in FIG. 3. For example, in various embodiments the training system 100 receives information from the perception system 74, develops the uncertainty model, and then provides the uncertainty model to the guidance system 78 and/or the vehicle control system 80 in order to train and control the vehicle 10.

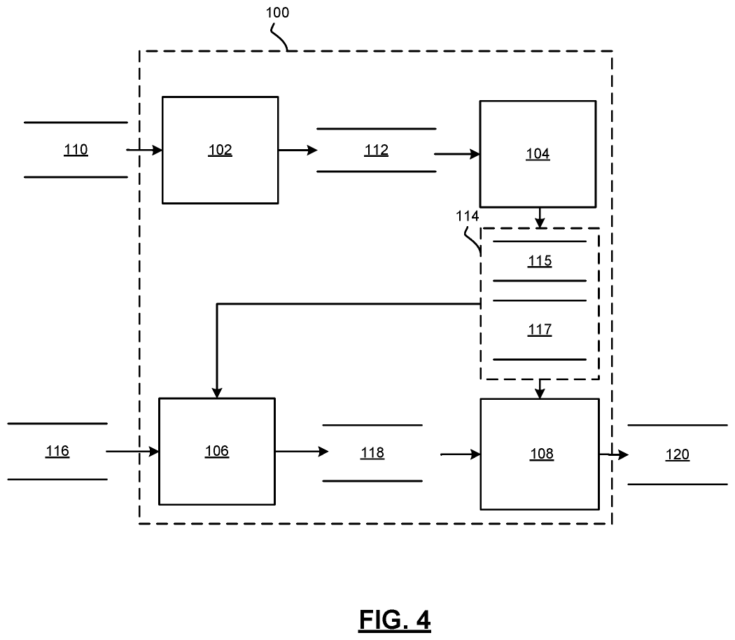

In that regard, FIG. 4 is a dataflow diagram illustrating aspects of the training system 100 in more detail. With reference to FIG. 4 and with continued reference to FIGS. 1-3, the training system 100 includes a data collection module 102, an object localization module 104, a range estimation module 106, and an uncertainty modeling module 108.

The data collection module 102 receives sensor data 110 generated by, for example, the sensor system 28 of the vehicle 10. The data collection module 102 processes the sensor data 110 to determine an image depicting a scene in the environment of the vehicle 10 and to produce corresponding scene data 112.

The object localization module 104 processes the scene data 112 to determine object data 114 including element data 115 corresponding to elements within the scene and bounding boxes around the elements. As can be appreciated, the elements can be detected using any object detection method and is not limited to any one example.

The object localization module 104 further processes the scene data 112 to determine ground truth data 117 including the ground truths of the elements and a second bounding box around the elements based on the ground truths. In various embodiments, the detection of the element data 115 and the ground truth data 117 of the object are not identical due to sensor noise, environment situations, and so on; thus, allowing for the determination of uncertainties.

The range estimation module 106 receives the object data 114 and sensor data 116. The sensor data 116 can include, for example, relatively accurate LIDAR sensor range information. The range estimation module 106 determines the distance or range information 118 (D_{GT}) between the vehicle 10 and the detected objects within the scene. For example, the ground truth object area in the scene is A_{GT} and the estimated object area is A_{D}, then the estimated distance to the object is D_{D}. Provided the following relation:

D_{D}/D_{GT}≈√(A_{D}/A_{GT}), (1)

and given that √A_{GT} should be “linearly” inverse-proportional to D_{GT} the distance or depth information can be estimated. In Equation (1), D_{D}/D_{GT} is the ratio of the uncertainty and if the value equals ‘1,’ it means a perfect sensor system.

For uncertainties in orientation and velocity, in addition to the range information 118, the uncertainties also depend on the detected box locations in the image with respect to the ground truth location. It is because the orientation and velocity uncertainties are related with lateral motions of the objects in the image plane, and the corresponding variable is |C_{D}-C_{GT}| where C_{GT} is the center pixel location of the ground truth bounding box of an object (vehicle) and C_{D} is that of the estimated bounding box of the corresponding object in the ‘normalized’ image coordinate (x, y values are ranged in [−0.5, 0.5]).

From the collected data 114, 116, the uncertainty model data 120 including range, velocity, and orientation can be computed for all detected elements. For example, the uncertainty modeling module 108 estimates the range uncertainty based on the following relation:

d′=d+G(0,σ_{D}(d)). (2)

Where σ_{D}(d) is the standard deviation of distance estimation for the measured distance d and G_{D}(m, n) is a Gaussian distribution with mean m and standard deviation n. The corresponding Gaussian distribution can be acquired from statistics of deviations between manually measured distance-to-targets (ground truth) and measured distance-to-targets from the sensors.

The uncertainty modeling module 108 estimates the angular uncertainty based on the following relation:

θ′=θ+G_{A}(0, σ_{A}(d))+H(C_{D}−C_{GT}, d). (3)

Where σ_{A} (d) is the standard deviation of relative angle estimation for the measured distance d. The Gaussian distribution, G_{A( )}, is acquired from statistics of angular deviations between manually measured orientational deviations to targets (ground truth) and measured orientational deviations to targets from the sensor mounted on the host vehicle. And H(C_{D}−C_{GT}, d) is an additional lateral deviation uncertainty for the orientation angles with the lateral deviation in the image plane and distance. The value of Gaussian distribution, H(C_{D}−C, d), is acquired based on the joint probability which has two variables of C_{D}−C_{GT} and d.

The uncertainty modeling module 108 estimates the velocity uncertainty based on the following relation:

v′=v+(G_{V}+0, σ_{V}(d))+H_{V}(C_{D}, −C_{GT}, d). (4)

Where σ_{V} (d) is the standard deviation of velocity estimation for distance d. The Gaussian distribution, G_{V( )} is acquired from statistics of velocity deviations between actual velocity of target vehicles (ground truth) and measured velocity from the sensor mounted on the host vehicle. And H(C_{D}−C_{GT}, d) is an additional lateral deviation uncertainty for the object velocities with the lateral deviation in the image plane and distance. The value of H(C_{D}−C_{GT}, d) is also acquired based on the joint probability which has two variables of C_{D}−C_{GT} and d.

From the above uncertainty model data 120, the new relative location with uncertainty with respect to the vehicle 10 location is geometrically estimated with d′ and θ′ by using x′=d′ cos θ′ and y′=d′ sin θ′. The estimated uncertainty model data 120 can be further used in training decision making functions of the vehicle 10. For example, in various embodiments, the uncertainties can be applied to decision making functions as a range of weights that are multiplied to the standard deviation of perception uncertainties, and the trained decision making functions are then used to control the vehicle 10.

It will be understood that various embodiments of the training system 100 according to the present disclosure may include any number of additional sub-modules embedded within the controller 34 which may be combined and/or further partitioned to similarly implement systems and methods described herein. Furthermore, inputs to the training system 100 may be received from the sensor system 28, received from other control modules (not shown) associated with the autonomous vehicle 10, received from the communication system 36, and/or determined/modeled by other sub-modules (not shown) within the controller 34 of FIG. 1. Furthermore, the inputs might also be subjected to preprocessing, such as sub-sampling, noise-reduction, normalization, feature-extraction, missing data reduction, and the like.

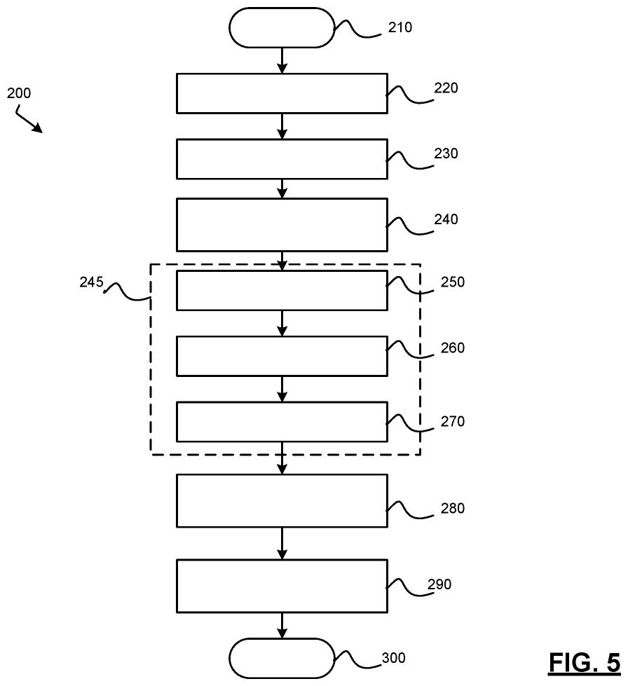

Referring now to FIG. 5, and with continued reference to FIGS. 1-4, a flowchart illustrates a control method 200 that can be performed by the training system 100 of FIG. 1 in accordance with the present disclosure. As can be appreciated in light of the disclosure, the order of operation within the method is not limited to the sequential execution as illustrated in FIG. 5, but may be performed in one or more varying orders as applicable and in accordance with the present disclosure. In various embodiments, the method 400 can be scheduled to run based on one or more predetermined events, and/or can run continuously during operation of the autonomous vehicle 10.

In various embodiments, the method may begin at 210. The sensor data 110 is received at 220. The sensor data 110 is processed to identify elements (bikes, other vehicles, pedestrians, etc.) within a scene at 230. The sensor data 110 is further processed to determine the object data 114 and range information 118 at 240.

Thereafter, the object data 114 and the range information 118 are processed to determine the uncertainty model data 120 at 245. For example, the range uncertainty is determined, for example, based on equation (2) above at 250. The orientation uncertainty is determined, for example, based on equation (3) above at 260. The velocity uncertainty is determined, for example, based on equation (4) above at 270.

Thereafter, the uncertainty model data 120 including the range uncertainty, the orientation uncertainty, and the velocity uncertainty are used in training decision making functions at 280. For example, as discussed above, in various embodiments, the uncertainties can be applied to decision making functions as a range of weights that are multiplied to the standard deviation of perception uncertainties.

Thereafter, the trained decision making functions are then used to control the vehicle 10 at 290; and the method may end at 300.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of controlling an autonomous vehicle, comprising:
receiving sensor data from one or more sensors of the vehicle;
processing, by a processor, the sensor data to determine object data indicating at least one element within a scene of an environment of the vehicle;
processing, by the processor, the sensor data to determine a ground truth data associated with the element;
determining, by the processor, an uncertainty model based on the ground truth data and the object data;
training, by the processor, vehicle functions based on the uncertainty model; and
controlling the vehicle based on the trained vehicle functions.

2. The method of claim 1, wherein the uncertainty model includes a range uncertainty.

3. The method of claim 1, wherein the uncertainty model includes an orientation uncertainty.

4. The method of claim 1, wherein the uncertainty model includes a velocity uncertainty.

5. The method of claim 1, wherein the determining the uncertainty model is based on a comparison of an object location of the object data to a ground truth location of the ground truth data.

6. The method of claim 1, wherein the training comprises generating perception system data based on the uncertainty model and training the vehicle functions based on the generated perception system data.

7. The method of claim 1, wherein the object data includes a bounding box surrounding the element within the scene, wherein the bounding box is identified by an object detection method.

8. The method of claim 7, wherein the object data further includes a distance to the element from the vehicle and a location of the element within the scene that is determined based on the bounding box.

9. The method of claim 1, wherein the ground truth data includes a bounding box surrounding the element within the scene, wherein the bounding box is identified by a ground truth detection method.

10. The method of claim 9, wherein the ground truth data further includes a distance to the element from the vehicle and a location of the element within the scene that is determined based on the bounding box.

11. A training system for an autonomous vehicle, comprising:
a non-transitory computer readable medium comprising:
a first module configured to, by a processor, receive sensor data from one or more sensors of the vehicle, process the sensor data to determine object data indicating at least one element within a scene of an environment of the vehicle, and process the sensor data to determine a ground truth data associated with the element;
a second non-transitory module configured to, by a processor, determine an uncertainty model based on the ground truth data and the object data; and
a third module configured to, by a processor, generate perception system data based on the uncertainty model and training vehicle functions of a vehicle controller based on the generated perception system data.

12. The system of claim 11, wherein the uncertainty model includes a range uncertainty.

13. The system of claim 11, wherein the uncertainty model includes an orientation uncertainty.

14. The system of claim 11, wherein the uncertainty model includes a velocity uncertainty.

15. The system of claim 11, wherein the uncertainty model is based on a comparison of an object location of the object data to a ground truth location of the ground truth data.

16. The system of claim 11, wherein the object data includes a bounding box surrounding the element within the scene, wherein the bounding box is identified by an object detection method.

17. The system of claim 16, wherein the object data further includes a distance to the element from the vehicle and a location of the element within the scene that is determined based on the bounding box.

18. The system of claim 11, wherein the ground truth data includes a bounding box surrounding the element within the scene, wherein the bounding box is identified by a ground truth detection method.

19. The system of claim 18, wherein the ground truth data further includes a distance to the element from the vehicle and a location of the element within the scene that is determined based on the bounding box.

20. An autonomous vehicle, comprising:
a plurality of sensors disposed about the vehicle and configured to sense an exterior environment of the vehicle and to generate sensor signals; and
a control module configured to, by a processor, process the sensor signals to determine object data indicating at least one element within a scene of an environment of the vehicle, process the sensor data to determine a ground truth data associated with the element, determine, an uncertainty model based on the ground truth data and the object data, train vehicle functions based on the uncertainty model, and control the vehicle based on the trained vehicle functions.
